(19) United States
(12) Patent Application Publication
(10) Pub. No.: US 2018/0170555 A1
(43) Pub. Date: Jun. 21, 2018

(54) ICE PROTECTION SYSTEM

(71) Applicant: HS Marston Aerospace Limited, Wolverhampton (GB)

(72) Inventor: Paul PHILLIPS, Bromsgrove (GB)

(21) Appl. No.: 15/844,829

(22) Filed: Dec. 18, 2017

(30) Foreign Application Priority Data
Dec. 16, 2016 (EP) 16275173.9

(51) Int. Cl. B64D 15/02; F28B 1/06

(52) U.S. Cl. CPC B64D 15/02; F28B 1/06

(57) ABSTRACT

A system for de-icing an aircraft structure or surface comprises an inert gas generating system comprising a catalyst for receiving fuel and oxygen and converting the fuel and oxygen to CO₂ and H₂O in gaseous form, and a condenser for condensing the H₂O to liquid form, the condenser providing heat to the aircraft structure or surface.

### FOREIGN PRIORITY

This application claims priority to European Patent Application No. 16275173.9 filed Dec. 16, 2016, the entire contents of which is incorporated herein by reference.

### TECHNICAL FIELD

The present disclosure relates to an ice protection system for an aircraft.

### BACKGROUND

Aircraft surfaces, for example control surfaces, are often provided with de-icing systems. Such systems may prevent the accumulation of ice on the surface or melt ice which has already accumulated on the surface.

Known de-icing systems may employ electrical heating elements or hot gas bled from an aircraft engine.

It is desirable to provide a de-icing system which mitigates the need to extract energy from the aircraft power supply.

### SUMMARY

According to one embodiment of the present disclosure, there is provided a system for de-icing an aircraft structure or surface. The system comprises an inert gas generating system which comprises a catalyst for receiving fuel and oxygen and converting the fuel and oxygen to CO2 and H2O in gaseous form, and a condenser for condensing the H2O to liquid form. The condenser provides heat to the aircraft structure or surface.

The condenser may be in direct or indirect thermal contact with the aircraft structure or surface.

For example, in certain embodiments, the condenser may be mounted to the aircraft structure or surface.

The condenser may be mounted to the aircraft structure or surface via a thermally conductive mount.

The mount may be aluminium or copper, for example.

In an alternative arrangement, the condenser may be integrated into the aircraft structure or surface.

The condenser may comprise a conduit which extends along or around a structure or surface to be protected.

In an alternative arrangement, in which the condenser is in indirect thermal contact with the aircraft structure or surface, the system may further comprise a heat transfer fluid receiving heat from the condenser, the fluid being conducted to the aircraft structure or surface.

The aircraft surface may be a wing or tail surface, for example a wing or tail leading edge, or an engine inlet for example.

The present disclosure also provides an aircraft comprising the system for de-icing an aircraft structure or surface of the present disclosure.

According to another embodiment of the present disclosure there is provided a method of de-icing an aircraft structure or surface, comprising the steps of removing heat from the output gas stream of an inert gas generating system, and supplying the heat to the aircraft structure or surface.

The step of removing heat from the output gas stream may comprise condensing water out of the output gas stream.

The step of supplying the heat to an aircraft structure or surface may comprise positioning a condenser in thermal contact with the aircraft structure or surface, the aircraft structure or surface being at a lower temperature than the condenser.

In an alternative arrangement, the step of supplying heat may comprise transferring heat from a condenser to a heating fluid which is conducted to said aircraft structure or surface.

### BRIEF DESCRIPTION OF THE DRAWINGS

Some exemplary embodiments and features of the present disclosure will now be described by way of example only, and with reference to the following drawings in which:

FIG. 1 shows a block diagram showing a fuel tank inerting system;

FIG. 2 shows a detail of the system of FIG. 1; and

FIG. 3 shows an example aircraft structure incorporating ice protection system in accordance with this disclosure.

### DETAILED DESCRIPTION

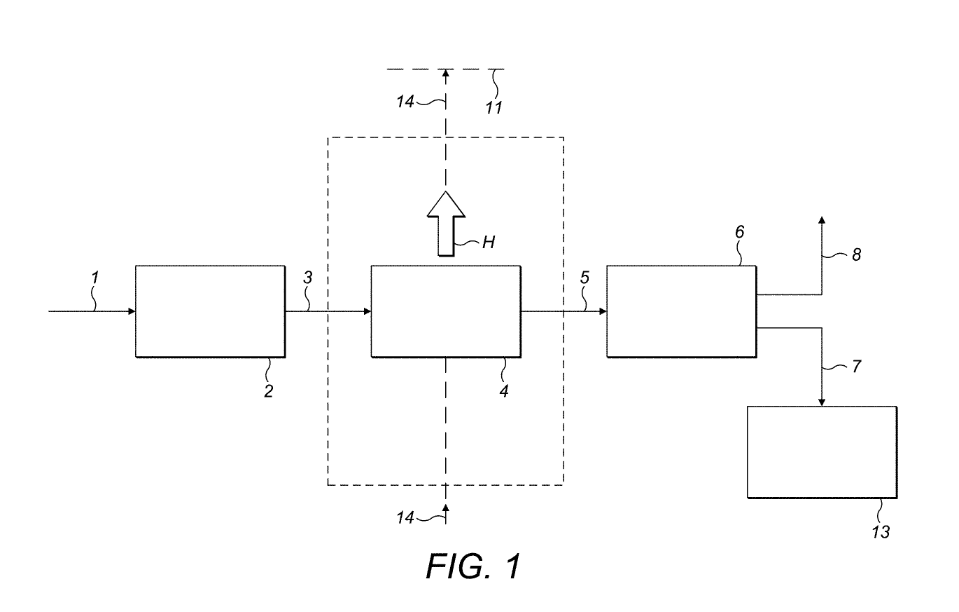

With reference to FIG. 1, an inert gas generating system for an aircraft is illustrated. Fuel vapour 1 is fed to a catalyst 2 with oxygen, which oxidises the fuel vapour to produce an inerting gas supply 3. The inerting gas supply 3 comprises carbon dioxide and water. The inerting gas supply 3 is directed to a condenser 4, which condenses water out of the inerting gas supply 3. The remaining two phase mixture 5 is supplied to a water separator 6, which separates the condensed water from the carbon dioxide. The carbon dioxide 7 is fed to a fuel tank 13 of the aircraft whilst the liquid water 8 is removed from the system. The carbon dioxide forms a protective atmosphere over the fuel in the fuel tank, reducing the likelihood of fuel vapour igniting in the fuel tank.

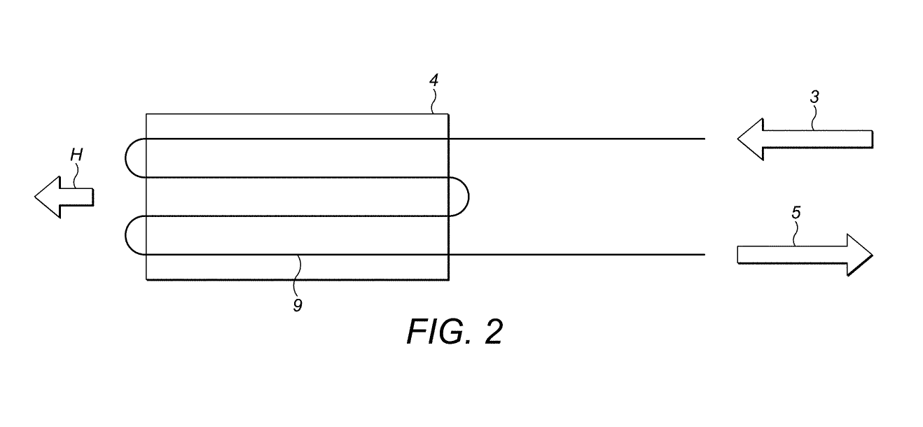

As illustrated schematically in FIG. 2, the condenser 4 includes a flow path 9 for the inerting gas supply 3, allowing heat transfer H to take place between an external cooling source and the inerting gas supply 3.

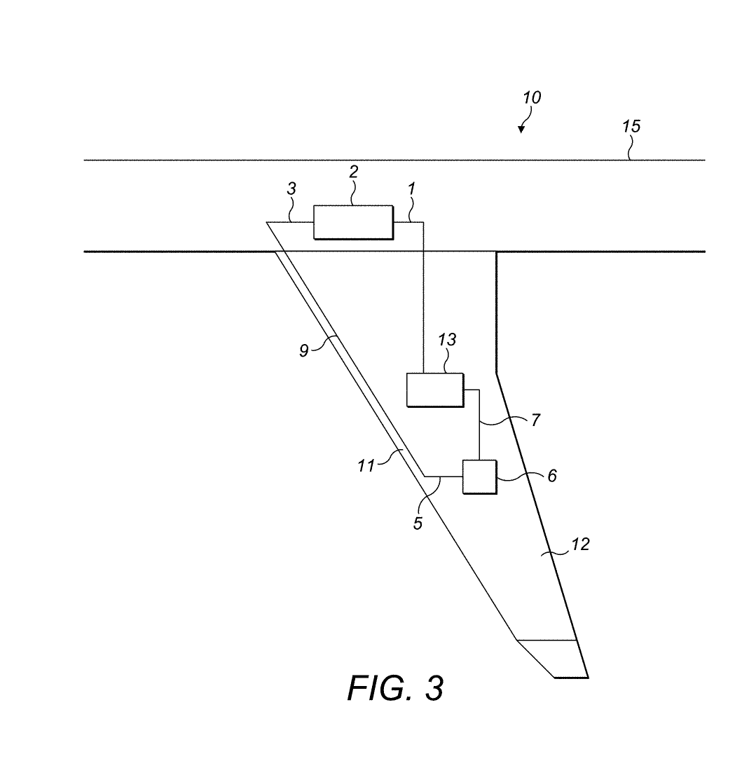

The system of FIGS. 1 and 2 is installed on board an aircraft 10, as illustrated schematically in FIG. 3. The aircraft 10 may include one or more fuel tanks 13. There may for example be a left wing tank 13 positioned in the left wing 12 of the aircraft, a right wing tank positioned in the right wing of the aircraft, and/or a centre tank positioned in the fuselage 15.

Certain areas of the aircraft 10, such as the leading edge 11 of the wing 12, may be susceptible to icing during operation of the aircraft 10 and therefore require ice protection. Other susceptible structures and surfaces may include engine intakes, tail surfaces, control surfaces etc. The Applicant has recognised that the heat produced in the condenser 4 may be used to provide such protection. Accordingly, the condenser 4 may be suitably arranged so as to provide heat to the appropriate surface.

The condenser 4 may be positioned in direct or indirect thermal contact with the aircraft structure or surface 11 to be heated, the heat produced in the condenser 4 being transmitted to the aircraft structure or surface 11 to be protected.

In arrangements where the condenser 4 is in direct thermal contact with the aircraft structure or surface 11, the condenser 4 may be mounted to the aircraft structure or surface 11, or otherwise integrated into the surface. The condenser 4 may, for example, be mounted to the surface to be protected via a thermally conductive plate, for example an aluminium or copper plate to promote good transfer of heat into the structure or surface 11.

The condenser 4 may, for example, comprise a conduit 9 which extends along a structure or surface to be protected. For example, as illustrated in FIG. 3, a conduit 9 may extend along a leading edge 11 of a wing 12.

The conduit 9 may be straight or tortuous to provide for appropriate water condensation and heat transfer.

As illustrated in FIG. 3, after passing along the condenser conduit 9, the two phase mixture 5 is fed to separator 6 and the carbon dioxide then fed to fuel tank 13 for inerting purposes.

In an alternative embodiment, in which the condenser is in indirect thermal contact with the aircraft structure or surface 11, a heat transfer fluid 14 may receive heat from the condenser 4 and be conducted to the aircraft structure or surface 11. This is illustrated schematically in FIG. 1. The heat transfer fluid may be gas, for example air, or liquid, and may be exhausted onto the aircraft structure or surface 11 or be conducted therethrough or therealong.

The embodiments described above may provide a number of advantages. They may provide a continual source of heat to the ice-prone aircraft structure or surface 11 throughout the operation of the aircraft, since the fuel tank inerting system will normally be in operation throughout an entire flight. The system is also, in effect, a passive system that does not require a separate electrical or pneumatic supply.

Although the figures and the accompanying description describe particular embodiments and examples, it is to be understood that the scope of this disclosure is not to be limited to such specific embodiments, and is, instead, to be determined by the following claims.

1. A system for de-icing an aircraft structure or surface, the system comprising:
an inert gas generating system comprising a catalyst for receiving fuel and oxygen and converting the fuel and oxygen to CO₂ and H₂O in gaseous form; and
a condenser for condensing the H₂O to liquid form, the condenser providing heat to the aircraft structure or surface.

2. The system of claim 1, wherein the condenser is mounted to the aircraft structure or surface.

3. The system of claim 2, wherein the condenser is mounted to the aircraft structure or surface via a thermally conductive mount.

4. The system of claim 3, wherein the thermally conductive mount is aluminium or copper.

5. The system of claim 1, wherein the condenser is integrated into the aircraft structure or surface.

6. The system of claim 1, wherein the condenser comprises a conduit which extends along or around the aircraft structure or surface.

7. The system of claim 1, further comprising a heat transfer fluid receiving heat from said condenser, the heated fluid being conducted to said aircraft structure or surface.

8. The system of claim 1, wherein the aircraft structure or surface is a wing or tail surface.

9. The system of claim 8, wherein the aircraft structure or surface is a leading edge of the wing or tail surface.

10. The system of claim 1, wherein the aircraft structure or surface is an engine inlet.

11. An aircraft comprising the system for de-icing an aircraft structure or surface of claim 1.

12. A method of de-icing an aircraft structure or surface, comprising the steps of:
removing heat from the output gas stream of an inert gas generating system; and
supplying the heat to the aircraft structure or surface.

13. The method of claim 12, wherein the step of removing heat from the output gas stream comprises condensing water out of the output gas stream.

14. The method of claim 13, wherein the step of supplying the heat to an aircraft structure or surface comprises arranging a condenser in thermal contact with the aircraft structure or surface.

15. The method of claim 13, wherein the step of supplying the heat to an aircraft structure or surface comprises transferring heat from a condenser to a heating fluid which is conducted to said aircraft structure or surface.
